(19) United States
(12) Patent Application Publication
(10) Pub. No.: US 2005/0129405 A1
(43) Pub. Date: Jun. 16, 2005

(54) Method and arrangement for signaling in a network comprising nodes with optical ports

(76) Inventor: Sten Hubendick, Stockholm (SE)

Correspondence Address: LADAS & PARRY LLP, 224 SOUTH MICHIGAN AVENUE, SUITE 1200, CHICAGO, IL, 60604, US

(21) Appl. No.: 10/503,962

(22) PCT Filed: Feb. 12, 2003
(86) PCT No.: PCT/SE03/00229

(30) Foreign Application Priority Data
Feb. 27, 2002 (SE) 0200583-3

(51) Int. Cl. H04J 14/08; G02F 1/153

(52) U.S. Cl. 398/100; 359/275

(57) ABSTRACT

The invention refers to a method and an arrangement for signaling in a network comprising nodes (A, B) provided with optical ports (2, 3). The optical ports have logic for signal loss detection and activation of optical output power or modulation control. The invention utilizes the logic for signal loss detection of transmis sion of information. Especially, the invention is utilized for transmission of topological information when ports and nodes are connected. According to the invention the information is transmitted by turning off and turning on the optical output power or modulation of the transmitting node. A port turned off provides an optical power or modulation below a threshold value, which corresponds to a logical level and a port turned on provides an optical power or modulation over a threshold value, which corresponds to another logical level. Nodes and ports can be connected in accordance with the method.

### FIELD OF INVENTION

The present invention refers to a method and an arrangement for signaling in a network comprising nodes with optical ports. The invention uses logic for signal loss detection at a receiving port of a node in order to be able to get information from a transmitting port of a node by means of turning off or turning on the output optical power or modulation, e.g. by controlling the output power or modulation of a laser in the node. Especially, the invention can be used to transmit topological information.

### PRIOR ART

In networks having link layer termination, exchange of information occurs so that automatic control over the topology is achieved. The use of transparent optical nodes, e.g. cross-connectors, involves however problems, since completely optical and optoelectrical nodes may not have any link layer termination in their transmission ports. Without link layer there is therefore no natural way to automatically detect the topology in a network when connecting new nodes or to fault trace topological information. All topological information must be specified manually.

The present invention solves the problem of providing transmission of information between optical equipment which do not have access to each other's data channels or are not provided with compatible link layer protocols.

The invention solves the problem by utilizing logic for signal detection, e.g. signal loss detection, often called Loss of Signal (LOS), which is located in the receiver of the node. The logic has two logical levels, which are used to transmit information.

Signal loss detection is normally used for detecting a broken fiber or transmitter and can detect optical power or modulation amplitude. It should be noted that the signal loss detect function cannot determine the characteristics of the modulation, i.e. the bit-rate etc., only that such modulation is present. The present inventors have realized that by turning on or turning off the output optical power or modulation, a novel communication channel outside the conventional data channel between nodes is formed and information, e.g. topological information, can be sent to the neighboring nodes.

As signal loss detection is used at virtually all equipment with optical ports, the invention can be used for, and between, a wide range of equipment types.

### SUMMARY OF THE INVENTION

The invention discloses a method for signaling in networks comprising nodes connected to each other by means of optical ports, such as optical cross-connectors. The node can for example comprise receiving ports with logic for signal loss detection and transmitting ports where the output optical power or modulation can be turned off or turned on. The transmitting ports can for example comprise lasers which can be turned off and turned on, but it should be understood that other light sources can be used and that they can be controlled in order to vary the optical power or modulation.

The present invention provides a solution to the above-mentioned problem, which solution comprises transmission of information, such as management or topological information, by means of logic for detection of signal losses and for activation of power or modulation control. The inventive logic is arranged externally to the data channel for data communication in order to detect signal losses and to activate the power or modulation control. By means of the present invention the topology of the network can be detected automatically when connecting new nodes to the network and topological information can be error traced.

According to an embodiment of the invention, information is sent by controlling the laser, e.g. controlling the intensity of the emitted light or the modulation amplitude. Thus, information can be sent by means of turning off and turning on the laser of the transmitting node. A laser turned off corresponds to a logical level and a laser turned on corresponds to another logical level.

Further, the present invention refers to a method and an arrangement for signaling in a network comprising nodes provided with optical ports having respective means for signal loss detection and activation of optical power or modulation control.

The invention also refers to connection of a port of a node to a network comprising nodes provided with optical ports having respective means for signal loss detection and activation of optical power or modulation control. Management or topological information can automatically be transmitted from a transmitting node to a neighboring node by controlling the output optical power or modulation of a port of said transmitting node, wherein a first output optical power or modulation corresponds to a first optical power or modulation received by said neighboring node, which first optical power or modulation amplitude is below a threshold value and corresponds to a first logical level, and wherein a second output power corresponds to a second optical power or modulation amplitude received by said neighboring node, which second optical power is over said threshold value and corresponds to a second logical level.

The information is preferably transmitted when the topology of the network is changed, for example when a node is connected to the network. The means for signal loss detection and activation of laser control is preferably arranged externally to a data channel providing data communication between said nodes.

Preferably, the information comprises topological information, such as identity number of the node, port number, IP-number and IP-port number. Nodes and ports can be connected in accordance with the method.

The invention also refers to a corresponding arrangement for signaling in network and corresponding node and cross-connector.

### BRIEF DESCRIPTION OF THE INVENTION

The invention will below be described in detail with reference to the accompanying drawings, in which:

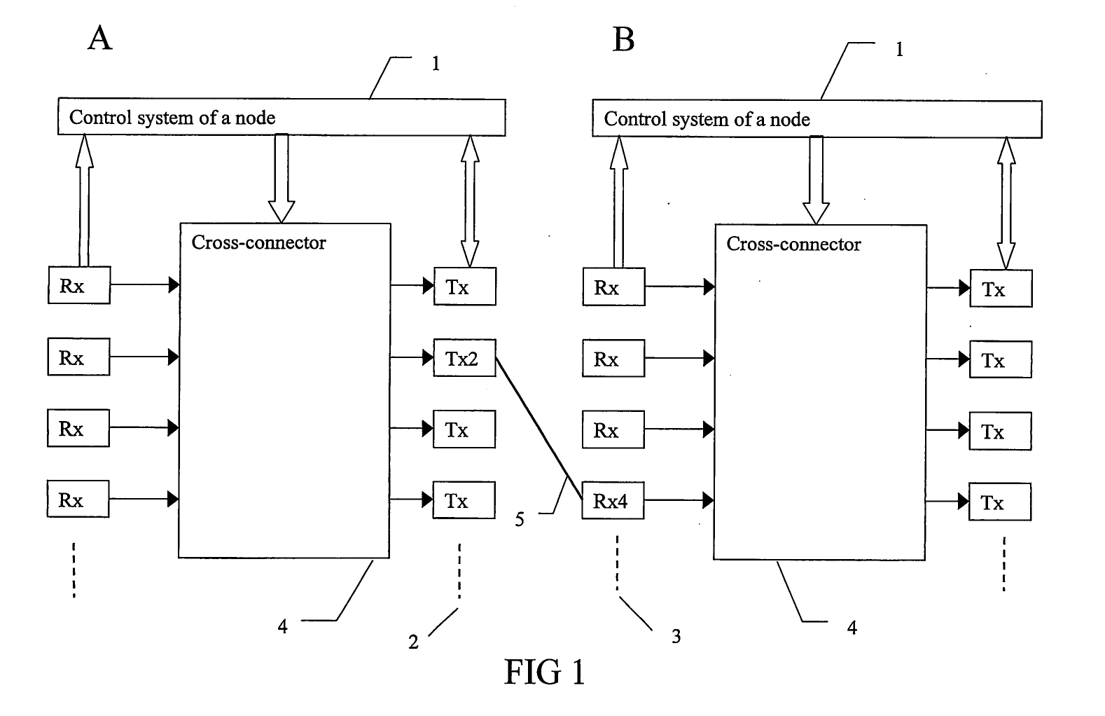

FIG. 1 is a schematic overview of two nodes which are to be connected;

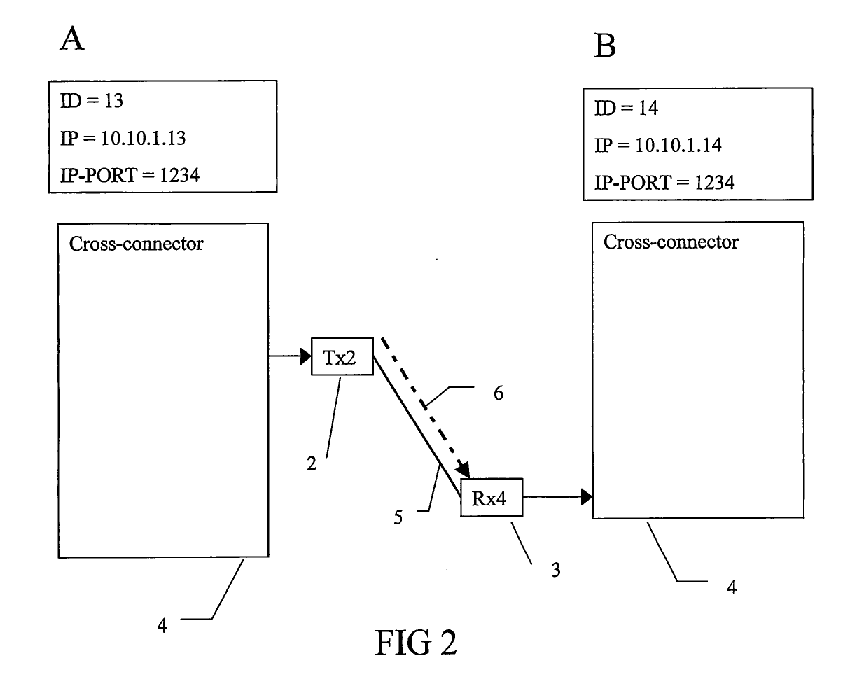

FIG. 2 is the corresponding drawing showing the affected ports and the information flow;

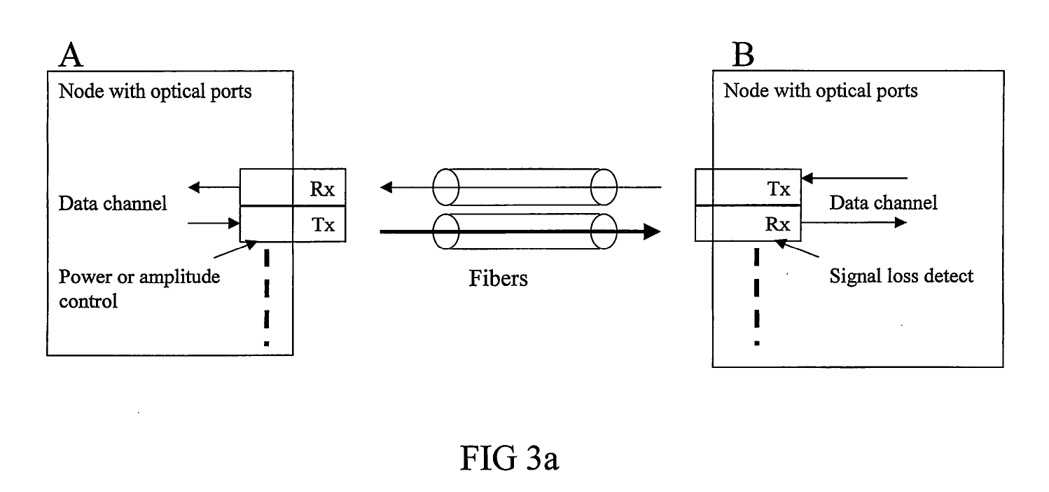

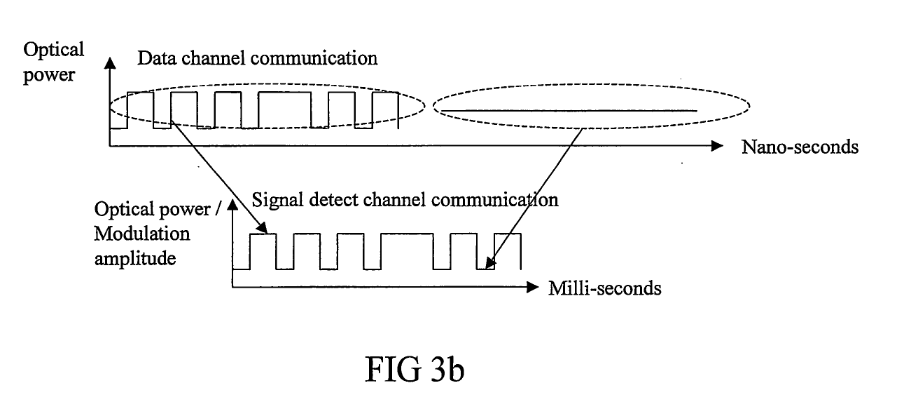

FIG. 3a shows schematically two nodes connected to each other by means of optical fibers; and

FIG. 3b shows two time-scales showing the difference between ordinary data channel communication and signal loss detection communication.

### DETAILED DESCRIPTION OF PREFERRED EMBODIMENTS

The invention is generally used in networks having nodes provided with optical ports, wherein the nodes in a special case are constituted of optical cross-connectors. In FIG. 1 two nodes A and B are shown, which nodes are to be connected. We disregard, the remaining connections of the nodes.

The invention will now be described with reference to nodes having optical ports and to optical cross-connectors. However, the invention is not intended to be limited to these devices, but can be implemented in any network comprising optical equipment having means for detecting signal losses. Such equipment can for example be WDM based devices (WDM, Wavelength Division Multiplexing), SDH-devices (SDH, Synchronous Digital Hierarchy), ATM-devices (ATM, Asynchronous Transfer Mode), IP-devices, etc.

Further, the invention will be described with reference to tuning off or turning on a laser of a node. However, other optical sources can be used and controlled in order to provided a variation in the output optical power or modulation. Different modulations are also possible, for example pulse amplitude modulation and pulse position modulation.

Each node has a control system 1 controlling the function of the node. The node has a number of transmitting ports (Tx) 2 and a number of receiving ports (Rx) 3. The traffic between the ports is switched within the node by the cross-connector 4. The nodes are connected to each other by means of an optic fiber 5. Information from a node is transmitted by controlling the intensity of the emitted light or modulation amplitude from one or several lasers comprised in the node.

The cross-connector 4 can be completely optical or optoelectrical. Opto-electrical cross-connectors have electrical termination, i.e. the optical input signal is detected and is transformed into an electrical signal, which is switched internally and then transmitted as optical signals by means of a laser. The laser beam is modulated in order to send information in the usual way. In optoelectrical cross-connectors it is simple to detect whether an input signal exists or not. In completely optical cross-connectors it is required that the signal is deflected and measured at a separate electrical termination.

Further, each receiver comprises logic for signal detection. Dependent on the value of the optically received power or modulation amplitude, two values can be adopted. If the mean value of the optically received power on the input port is above a certain threshold value, the logical value is SD=TRUE. If the mean value of the optical power on the input port is below the threshold value, the logical value is SD=FALSE. It is this logic that is used in the present invention. By setting TRUE=1 and FALSE=0 (or vice versa), data can be transmitted between two neighboring nodes by turning off and turning on the optical power or modulation, e.g. by controlling a laser of the node. As the time-scale of the SD function is in the order of 100 microseconds, this is not to be confused with the ordinary nanosecond communication over the optical ports.

In other words, if the laser of a transmitting node is turned off, the optical power or modulation is zero and whereby SD=FALSE at the receiver, which corresponds to transmitting a zero. However, the power or modulation of the laser or port can also be reduced to provide a received power below the threshold value, whereby SD=FALSE at the receiver. If the laser optical power or modulation is turned on, the optical power or modulation will become higher than the threshold value (provided that the transmission distance does not attenuate too much, that is that the fiber functions) and whereby SD=TRUE, which corresponds to transmitting a one. A data speed and a coding protocol have to be determined in advance. Information can then be sent between the ports in this manner.

As shown in FIG. 2, each node has identity information which can be used to identify the node and to describe the topology of the network. The information is usually node identity number, port number, IP-number and IP-port number. For node A, the node identity number is ID=13, IP-number is IP=10.10.1.13, and IP-port number is IP-PORT=1234. The ports are continuously numbered for respective port.

This information is sufficient to automatically determine the topology in a fiber network and later to initiate communication over IP.

The only thing required is that there is an interface for writing and reading characters from a bit stream, e.g. an interface for writing and reading 8 bits characters from a bit stream. As character table, standard ANSI is used.

The character stream is interpreted for e.g. XML-coded text. In XML, tags can be pre-determined as follows:

<NODE_ID>13</NODE_ID>
<NODE_TXPORT>2</NODE_TXPORT>
<IP_ADDRESS>10.10.1.13</IP_ADDRESS>
<IP_PORT>1234</IP_PORT

In FIG. 2, the transmitting port (Tx2) 2 of node A is to be connected to the receiver port (Rx4) 3 of node B. The control system of node A instructs the transmitting laser of the transmitter port Tx2 to transmit information by turning off and turning on the optical power or modulation as described above. The information is transmitted via the fiber 5 as shown by the arrow 6. The receiving port Rx4 of the node B detects the signaling and extracts information from the transmitting node A. Thereby is the signaling completed and detecting nodes have received topological information about how the transmitting node is connected to them and information to be able to contact the new node over IP.

When connecting a completely new node, one transverses the method above for each port, which is to be connected. The above described method can be performed in serial, i.e. for one port at a time, or in parallel, i.e. for all ports at a time.

FIG. 3a shows a transmitting node A connected to a receiving node B by means of optical fibers. The transmitting node A has at least one optical port, which uses output power or modulation control to transmit information outside the data channel. A possible signal loss detection function is not shown. The figure further shows a receiving node B with at least one optical port, which uses signal loss detect to receive information outside the data channel. A possible output power or modulation control function is not shown. The signal loss channel uses the optical power or modulation of the data channel to determine signal loss detection. When the signal loss detection communication is used, the ordinary data channel cannot be used since turning off the output power or modulation blocks this channel.

Two time scales showing the difference between ordinary data channel communication and signal loss detection communication are shown in FIG. 3b. The upper time scale shows a time-graph of the ordinary data channel with bit-rates in the Gb/s range and the lower time scale shows a time-graph of signal loss detection communication with bit-rates in the kb/s range. The first part of the upper graph corresponds to power or modulation turned on, which in the lower graph gives rise to signal detection at the receiving node B. The second part of the upper graph corresponds to power or modulation turned off, which in the lower graph gives rise to signal loss detection at the receiving node B.

The invention thus provides a method and an arrangement for automatic transmission of information, e.g. topological information, which can be used in optical network having nodes without normal link layer termination.

### EXAMPLE

In a general automatic circuit switched network, four steps are performed before working traffic is transmitted in the network. Firstly, the nodes in the network detect their neighbors and the links they have in common. Secondly, the information detected by each node is distributed to all the other nodes in the network in order to provide topological information to them. Thirdly, when the topological information is available to all the nodes, each node can at a request for connection make a routing for the requested circuit. Fourthly, the routing is signaled in order to allocate the needed resources. Thus, in such a network these four steps is performed before data is transmitted in the network. Since the detection of neighboring nodes is performed before the data transmission, the invention functions even though the optical ports are unavailable for data transmission during the detection of neighboring nodes.

However, in a centralized automatic circuit switched network, the three last steps can be performed as above with the difference that the communication can be done with a central management system.

1. Method for signaling in a network comprising nodes provided with optical ports having respective logic for signal detection and lasers which can be turned off and on, wherein information is transmitted to a neighboring node by turning off and on the laser of a transmitting node, and wherein a laser turned off provides an optical power below a threshold value, which power corresponds to a logical level and a laser turned on provides an optical power over said threshold value, which power corresponds to another logical level, and wherein said logic for signal detection is arranged externally to a data channel providing data communication between said nodes.

2. Method for signaling in a network comprising nodes provided with optical ports having respective means for signal loss detection and activation of optical output power or modulation control, wherein information is automatically transmitted, when the topology of the network is changed, from a transmitting node to a neighboring node by controlling the output power or modulation of a port of said transmitting node, wherein a first output power or modulation corresponds to a first optical power or modulation received by said neighboring node, which first optical power or modulation amplitude is below a threshold value and corresponds to a first logical level, and wherein a second output power corresponds to a second optical power or modulation received by said neighboring node, which second optical power or modulation amplitude is over said threshold value and corresponds to a second logical level.

3. Method according to claim 2, wherein said means for signal loss detection and activation of optical output power or modulation control is arranged externally to a data channel providing data communication between said nodes.

4. Method according to claim 1 or 2 wherein the information is transmitted using byte coding.

5. Method according to claim 1 or 2, wherein the information comprises topological information.

6. Method according to claim 5, wherein the topological information comprises node identity number, port number, IP-number and IP-port number.

7. Method for connecting a port of a node to a network comprising nodes provided with optical ports having respective logic for signal detection and lasers which can be turned off and turned on, wherein information is transmitted to a neighboring node by turning off and turning on a laser of a transmitting node, and wherein a laser turned off provides an optical power below a threshold value, which power corresponds to a logical level and a laser turned on provides an optical power over said threshold value, which power corresponds to another logical level, and wherein said logic for signal detection is arranged externally to a data channel providing data communication between said nodes.

8. Method according to claim 7, wherein information is transmitted using byte coding.

9. Method according to claim 7 or 8, wherein the information comprises topological information.

10. Method according to claim 9, wherein the topological information comprises node identity number, port number, IP-number and IP-port number.

11. Method for connecting a port of a node to a network comprising nodes provided with optical ports having respective means for signal loss detection and activation of optical output power or modulation control, wherein information is automatically transmitted, when the node is connected, from said connected node to a neighboring node by controlling the output power or modulation of a port of said connected node, wherein a first output power corresponds to a first optical power received by said node, which first optical power or modulation amplitude is below a threshold value and corresponds to a first logical level, and wherein a second output power or modulation amplitude corresponds to a second optical power or modulation amplitude received by said node, which second optical power or modulation amplitude is over said threshold value and corresponds to a second logical level.

12. Method according to claim 11, wherein said means for signal loss detection and activation of optical output power or modulation control is arranged externally to a data channel providing data communication between said nodes.

13. Method according to claim 11 or 12, wherein information is transmitted using byte coding.

14. Method according to claim 11 or 12, wherein the information comprises topological information.

15. Method according to claim 14, wherein the topological information comprises node identity number, port number, IP-number and IP-port number.

16. Method for connecting a node to a network comprising nodes provided with optical ports with respective logic for signal detection and laser which can be turned off and turned on, wherein each port of the node which is connected is connected in accordance with claim 7.

17. Method for connecting a node to a network comprising nodes provided with optical ports with respective means for signal loss detection and activation of optical output power or modulation control, wherein each port of the node which is connected is connected in accordance with claim 11.

18. Arrangement for signaling in a network comprising nodes provided with optical ports having respective logic for signal detection and lasers which can be turned off and on, wherein information is transmitted to a neighboring node by turning off and on the laser of a transmitting node, wherein a laser turned off provides an optical power below a threshold value, which power corresponds to a logical level and a laser turned on provides an optical power over said threshold value, which power corresponds to another logical level, and in that said logic for signal detection is arranged externally to a data channel providing data communication between said nodes.

19. Arrangement for signaling in a network comprising nodes provided with optical ports having respective means for signal loss detection and activation of optical output power or modulation control, wherein the optical ports of a transmitting node are arranged to transmit information, when the topology of the network changes, to a neighboring node by controlling the output power or modulation of said transmitting node, wherein a first output power or modulation corresponds to a first optical power received by said node, which first optical power or modulation is below a threshold value and corresponds to a first logical level, and wherein a second output power or modulation corresponds to a second optical power received by said node, which second optical power is over said threshold value and corresponds to a second logical level.

20. Arrangement according to claim 19, wherein said means for signal loss detection and activation of optical output power or modulation control is arranged externally to a data channel providing data communication between said nodes.

21. Arrangement according to claim 18 or 19, wherein the optical port (2, 3) has a coding protocol which uses byte coding.

22. Arrangement according to claim 18 or 19, wherein the information comprises topological information.

23. Arrangement according to claim 22, wherein the topological information comprises node identity number, port number, IP-number and IP-port number.

24. Node for use in an arrangement according to claim 18 or 19.

25. Cross-connector for use in an arrangement according to claim 18 or 19.
